(19) United States
(12) Patent Application Publication
(10) Pub. No.: US 2013/0054753 A1
(43) Pub. Date: Feb. 28, 2013

(54) ELECTRONIC DEVICE AND METHOD FOR DOWNLOADING CONTENT

(71) Applicants: HUAI-YANG LONG, Shenzhen City (CN); CHIH-SAN CHIANG, Tu-Cheng (TW); YUN ZHAO, Shenzhen City (CN); YUE-FENG YE, Shenzhen City (CN); HUA-DONG CHENG, Shenzhen City (CN); HAN-CHE WANG, Tu-Cheng (TW)

(72) Inventors: HUAI-YANG LONG, Shenzhen City (CN); CHIH-SAN CHIANG, Tu-Cheng (TW); YUN ZHAO, Shenzhen City (CN); YUE-FENG YE, Shenzhen City (CN); HUA-DONG CHENG, Shenzhen City (CN); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen)CO., LTD., Shenzhen City (CN)

(21) Appl. No.: 13/304,319

(22) Filed: Nov. 24, 2011

(30) Foreign Application Priority Data
Aug. 29, 2011 (CN) 201110250773.1

(51) Int. Cl. G06F 15/16

(52) U.S. Cl. 709/219

(57) ABSTRACT

An electronic device includes a communication unit communicate with a network, a processing unit, and a storage unit. The processing unit controls the communication unit to transmit keywords to the network in response to user input, and controls the communication unit to transmit a download request of addresses of searched content of the network to target mobile terminal(s) selected from at least one mobile terminal communicating with the communication unit. The download request searches the network for content associated with the download addresses, the searched content are downloaded to the target mobile terminal(s).

### BACKGROUND

1. Technical Field

The present disclosure relates to an electronic device and method for downloading content.

2. Description of the Related Art

Mobile terminals, such as personal digital assistant (PDAs) and e-books, provide small user interfaces and limited functions for users to scan and search network resources. Commonly, the mobile terminals have to communicate with a personal computer (PC) to download selected network resources to the PC first. It is inconvenient and uncomfortable for the users at that moment to operate the mobile terminal to search and download.

Therefore, there is room for improvement within the art.

### BRIEF DESCRIPTION OF THE DRAWINGS

The components in the drawing are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a system capable of downloading content in accordance with an exemplary embodiment.

FIG. 2 is a schematic view showing a user interface provided by a intermediate proxy server of the system of FIG. 1 to show searched result, in accordance with an exemplary embodiment.

FIG. 3 is a schematic view showing a user interface provided by the intermediate proxy server of the system of FIG. 1 to show addresses of mobile terminals communicating with the intermediate proxy server, in accordance with an exemplary embodiment.

FIG. 4 is a schematic view showing a user interface provided by the intermediate proxy server of the system of FIG. 1 to input addresses of mobile terminals communicating with the intermediate proxy server, in accordance with an exemplary embodiment.

FIG. 5 is a schematic view showing a user interface provided by a mobile terminal of the system of FIG. 1 to show downloading information, in accordance with an exemplary embodiment.

FIG. 6 is a flow diagram that describes steps in a method in accordance with an exemplary embodiment.

### DETAILED DESCRIPTION

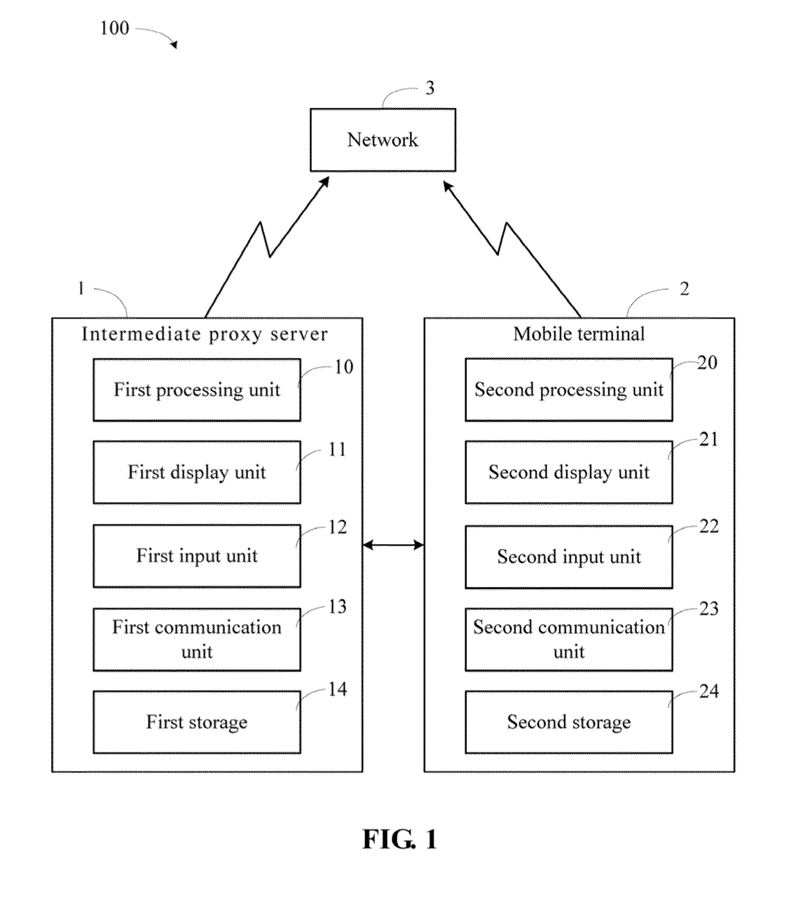

FIG. 1 is a block diagram of a system 100 capable of downloading content. The system 100 includes an intermediate proxy server 1 and at least one mobile terminal 2. The server 1 may be a personal computer (PC) server or a notebook computer (NC) server. The at least one mobile terminal 2 may be a smart phone, a PDA, or an e-book. The server 1 wirelessly communicates with the mobile terminal 2. The server 1 and the mobile terminal 2 both communicate with a network 3 such as the Internet.

The server 1 includes a first processing unit 10, a first display unit 11, a first input unit 12, a first communication unit 13, and a first storage 14. The first communication unit 13 (e.g. wireless fidelity (WIFI) communication module), is in communication with the server 1 and with the at least one mobile terminal 2. The first display unit 11 may be a touch-sensitive display. The first processing unit 10 displays a first user interface on the display unit 11 for users to input one or more keywords in response to user input using the first input unit 12 (e.g., mouse, touchpad, touchscreen). The first processing unit 10 transmits the keywords to the network 3 to request the network 3 to search content including the keywords and transmits searched results including download addresses (e.g., website links) of the searched content to the server 1.

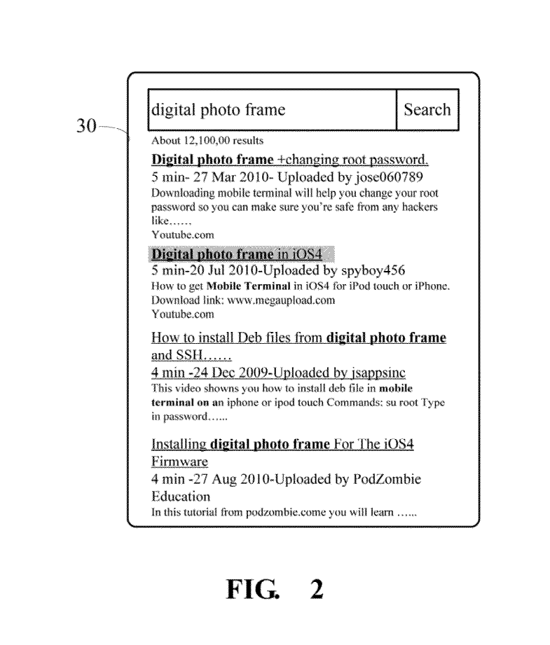

Referring to FIG. 2, when the first processing unit 10 receives the searched results from the network 3, the first processing unit 10 displays a second user interface 30 on the display unit 11 to show the searched results for users to make a selection(s). The first processing unit 10 stores the download addresses associated with the searched results in the first storage 14.

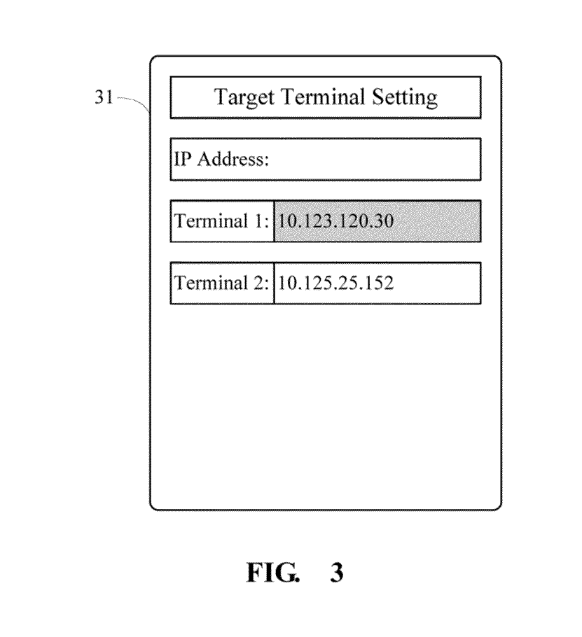

The first processing unit 10 selects one or more target mobile terminals from the at least one mobile terminal 2, and controls the first communication unit 13 to transmit the a download request of addresses of searched content of the network 3 to the one or more target mobile terminals. The download request includes the download addresses of the searched content. In the embodiment, the first processing unit 10 may obtain IP addresses of the at least one mobile terminal 2, and displays a third user interface 31 (see FIG. 3) on the display unit 11 to show the obtained IP addresses of the at least one mobile terminal 2. The first processing unit 10 selects the target mobile terminal 2 by selecting the corresponding IP address displayed on the third user interface by user.

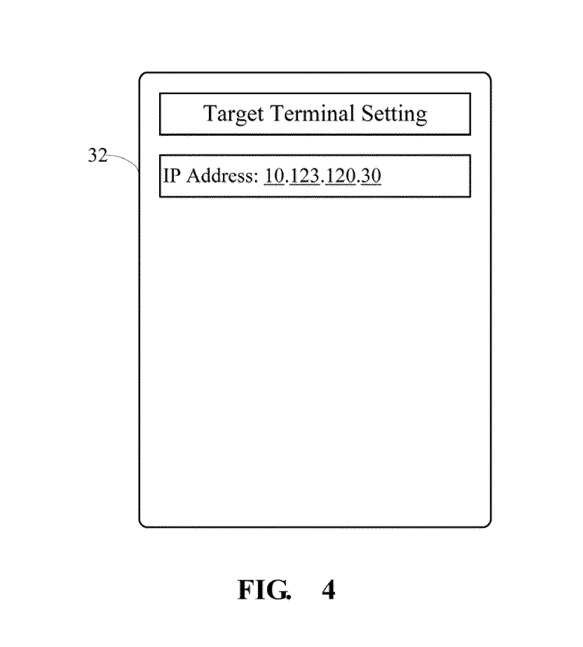

In an alternative embodiment, the first processing unit 10 displays an input interface 32 (see FIG. 4) on the first display unit 11. The first processing unit 10 selects the target mobile terminal 2 by inputting the corresponding IP address on the input interface by user.

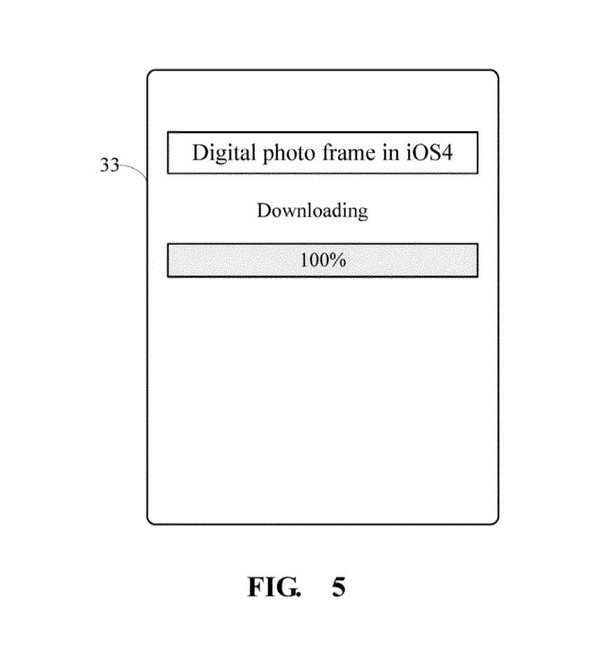

Each mobile terminal 2 includes a second processing unit 20, a second display unit 21, a second input unit 22, a second communication unit 23, and a second storage 24. The second input unit 22 accepts input information from users. The second communication unit 23 communicates with the first communication unit 11. When the second processing unit 20 receives the download request from the server 1, the second processing unit 20 controls the second communication unit 23 to transmit the download request including the download addresses and a storage path of the mobile terminal 2 to the network 3 to request the network 3 to search content associated with the download addresses and downloads the searched content to the second storage 24 according to the storage path. The second processing unit 20 can further display a downloading interface 33 (see in FIG. 5) on the second display unit 21 to show a download progress.

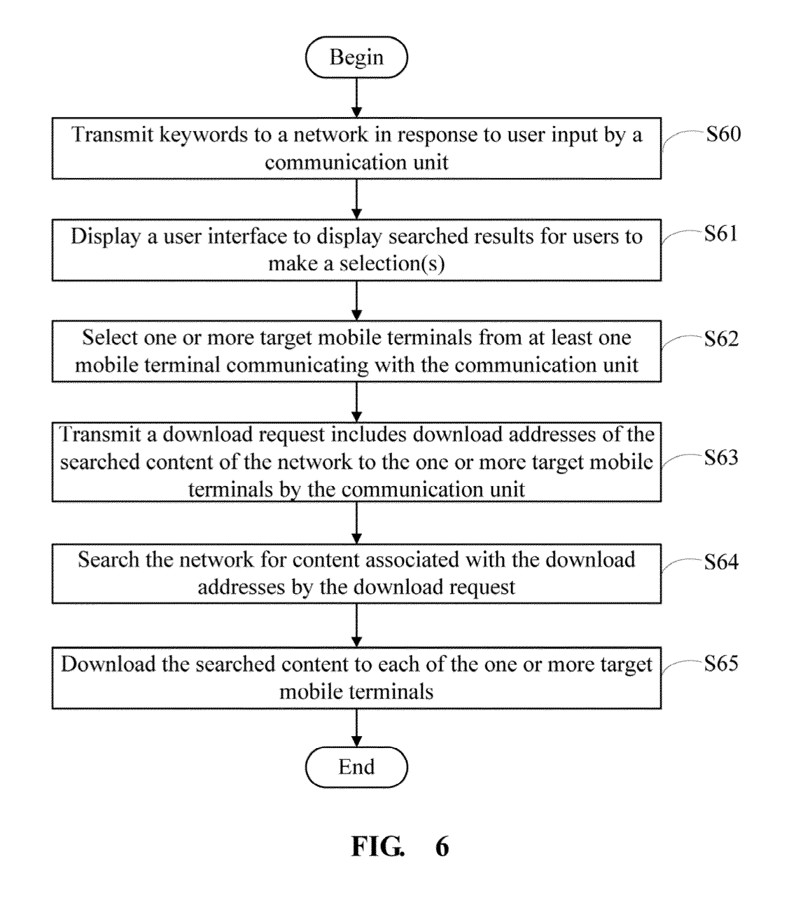

FIG. 6 is a flow diagram that describes steps in a method in accordance with an exemplary embodiment.

In step S60, the first processing unit 10 transmits the one or more keywords to the network 3 to request the network 3 to search content including the keywords and transmit searched results including download addresses of the searched content to the server 1.

In the embodiment, the first processing unit 10 displays a first touch user interface on the first display unit 11 for users to input the one or more keywords.

In step S61, when the first processing unit 10 receives the searched results from the network 3, the first processing unit 10 displays a second user interface 30 on the first display unit 11 to display the searched results for users to make a selection(s).

In step S62, the first processing unit 10 selects the one or more target mobile terminals from the at least one mobile terminal 2 communicating with the intermediate proxy server 1 in responds to user selection.

In the embodiment, the first processing unit 10 may obtain IP addresses of the at least one mobile terminal 2, and displays the obtained IP addresses of the at least one mobile terminal 2 on the display unit 11. The first processing unit 10 selects the target mobile terminal by selecting the corresponding IP address displayed on the display unit 11 by user.

In an alternative embodiment, the first processing unit 10 displays an input interface 32 (see FIG. 4) on the first display unit 11. The first processing unit 10 selects the target mobile terminal by inputting the corresponding IP address on the input interface by user.

In step S63, the first processing unit 10 transmits the download request of addresses of searched content of the network to the one or more target mobile terminals 2, and the download request includes download addresses of the searched content.

In step S64, when the second processing unit 20 receives the download addresses from the server 1, the second processing unit 20 transmits the download request including the download addresses and the storage path of the mobile terminal 2 to the network 3 to request the network 3 to search content associated with the download addresses.

In step S65, the second processing unit 20 downloads the searched content to the second storage 24 according to the storage path.

The second processing unit 20 displays the download interface 33 (see in FIG. 5) on the second display unit 21 to show the download progress.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a communication unit configured to communicate with a network;
a processing unit configured to control the communication unit to transmit one or more keywords to the network in response to user input, select one or more target mobile terminals from at least one mobile terminal that are communicating with the communication unit, and further control the communication unit to transmit a download request of addresses of searched content of the network to the one or more target mobile terminals, wherein the download request comprises download addresses of the searched content, wherein the download request searches the network for content associated with the download addresses, and the searched content are downloaded to the one or more target mobile terminals; and
a storage unit configured to store the download addresses associated with the searched results.

2. The electronic device as recited in claim 1, wherein the electronic device is an intermediate proxy server.

3. The electronic device as recited in claim 1, further comprising a display unit, the processing unit is configured to display a user interface on the display unit for users to input the one or more keywords.

4. The electronic device as recited in claim 3, wherein the processing unit is configured to display a user interface on the display unit to show the searched results for users to select the one or more searched results.

5. The electronic device as recited in claim 1, wherein the processing unit selects the one or more target mobile terminals by obtaining corresponding IP addresses from the at least one mobile terminal.

6. The electronic device as recited in claim 1, wherein the processing unit selects the one or more target mobile terminals by inputting corresponding IP addresses by a user.

7. A method for downloading content applied in an electronic device, the electronic device comprising a communication unit configured to communicate with a network, wherein the method comprises:
transmitting one or more keywords to the network in response to user input by the communication unit;
selecting one or more target mobile terminals from at least one mobile terminal communicating with the communication unit;
transmitting a download request of addresses of searched content of the network to the one or more target mobile terminals by the communication unit, wherein the download request comprises download addresses of the searched content;
searching the network for content associated with the download addresses by the download request; and
downloading the searched content to each of the one or more target mobile terminals.

8. The method as recited in claim 7, wherein a user interface is presented for user to input the one or more keywords.

9. The method as recited in claim 7, wherein the one or more target mobile terminals are selected by obtaining corresponding IP addresses from the at least one mobile terminal.

10. The method as recited in claim 7, wherein the one or more target mobile terminals are selected by inputting corresponding IP addresses by a user.
